(19) United States
(12) Patent Application Publication
(10) Pub. No.: US 2015/0156387 A1
(43) Pub. Date: Jun. 4, 2015

(54) IMAGE SENSOR, IMAGE SENSOR OPERATION METHOD, AND IMAGING APPARATUS

(71) Applicant: SONY CORPORATION, Tokyo (JP)

(72) Inventor: DAISUKE MIYAKOSHI, KANAGAWA (JP)

(21) Appl. No.: 14/551,493

(22) Filed: Nov. 24, 2014

(30) Foreign Application Priority Data
Dec. 3, 2013 (JP) 2013-250116

(51) Int. Cl. H04N 5/235

(52) U.S. Cl. CPC H04N 5/2353

(57) ABSTRACT

There is provided an image sensor including an imaging element that generates a pixel signal through photoelectric conversion with a variable exposure time; and an accumulation unit that accumulates the pixel signal generated by the imaging element, in which the imaging element repeatedly generates the pixel signal through the photoelectric conversion for each of the divided exposure time periods obtained by dividing a necessary exposure time which is necessary for imaging an image into multiple time periods at intervals of a predetermined time within an imaging time of one frame image, and the accumulation unit accumulates the pixel signal generated by the imaging element and outputs the pixel signal accumulated in the necessary exposure time.

### CROSS REFERENCE TO RELATED APPLICATIONS

This application claims the benefit of Japanese Priority Patent Application JP 2013-250116 filed Dec. 3, 2013, the entire contents of which are incorporated herein by reference.

### BACKGROUND

The present technology relates to an image sensor, an image sensor operation method, and an imaging apparatus, and particularly to an image sensor, an image sensor operation method, and an imaging apparatus which are capable of suppressing jerkiness while preventing a pixel signal from being saturated even when a Neutral Density (ND: light reduction) filter or the like is not used in imaging of a bring scene or the like.

A diaphragm or a shutter speed (exposure time) at the time of imaging is determined by a charge amount (sensitivity) photoelectrically converted in a pixel for a certain time and a saturated signal amount (Qs) which can be accumulated for each pixel.

In a case where the sensitivity of a pixel is increased such that an image signal can be acquired in a large amount even with a small amount of light for decreasing noise of a scene with low illuminance and a dark portion in a screen, it is necessary to increase the saturated signal amount at the same time. However, it is difficult to increase the sensitivity and the saturated signal amount in a certain area at the same time due to a restricted pixel area, it is necessary to perform design in which a balance between the sensitivity and the saturated signal amount is achieved.

Here, in an imaging element with a high sensitivity ratio with respect to the saturated signal amount, in a case where a bright scene that exceeds the saturated signal amount which can be accumulated in a pixel is imaged, an ND filter is inserted into the outside portion, an iris is stopped, or the shutter speed is increased (that is, the exposure time is shortened) so that the amount of light to be incident is decreased (see Japanese Unexamined Patent Application Publication No. 2002-135646).

### SUMMARY

However, in the above-described technique, since imaging procedures are complicated due to replacement of the ND filter, there is a concern that the operability may be degraded. Further, the degree of freedom for photographic expression in, for example, adjustment of a depth of field using the iris (F value) or a manner of showing a subject that flows using the shutter speed, is restricted.

In addition, there is a concern that a phenomenon in which light in accordance with the size of a unit pixel is not collected thereby causing the image to be out of focus and which is referred to as a so-called small diaphragm blur may occur because an optical light collection limit (airy disk) is widened when stopping the iris of a lens.

Further, in a case where a moving image is imaged, when the shutter speed is increased, there is a concern that a phenomenon which is referred to as jerkiness in which a moving subject in a continuous moving image appears at intervals may occur.

It is desirable to obtain an optimum image output even when the diaphragm and the shutter speed are freely set by a user without concern to the amount of light which is incident by dividing a set exposure time into multiple time periods to be set with a predetermined time interval and by adding pixel signals obtained in the divided exposure time periods, and it is desirable to improve the jerkiness by shortening a total exposure time at the time of a moving image mode in which a moving image is imaged.

According to an embodiment of the present technology, there is provided an image sensor including: an imaging element that generates a pixel signal through photoelectric conversion with a variable exposure time; and an accumulation unit that accumulates the pixel signal generated by the imaging element, in which the imaging element repeatedly generates the pixel signal through the photoelectric conversion for each of the divided exposure time periods obtained by dividing a necessary exposure time which is necessary for imaging an image into multiple time periods at intervals of a predetermined time within an imaging time of one frame image, and the accumulation unit accumulates the pixel signal generated by the imaging element and outputs the pixel signal accumulated in the necessary exposure time.

The image sensor may further include a conversion unit that converts the pixel signal formed of an analog signal output by the imaging element into a digital signal, in which the accumulation unit may accumulate the pixel signal converted into the digital signal by the conversion unit.

The image sensor may further include an arithmetic unit that reads the pixel signal accumulated in the accumulation unit, adds the pixel signal converted into the digital signal by the conversion unit to the read pixel signal, and writes the pixel signal back to the accumulation unit when the pixel signal is generated by the imaging element for each of the divided exposure times.

The image sensor may further include a divided exposure time determining unit that determines the divided exposure time based on a signal level of the pixel signal output by the accumulation unit. The divided exposure time determining unit may shorten the divided exposure time by a predetermined time when the signal level of the pixel signal output by the accumulation unit is saturated in a case where a moving image is imaged at a predetermined opening degree of a diaphragm.

The accumulation unit may be provided in the imaging element. The accumulation unit may accumulate the pixel signal as the analog signal. In the image sensor, each of the divided exposure times may be separated from each other.

According to another embodiment of the present technology, there is provided a method of operating an image sensor which includes an imaging element that generates a pixel signal through photoelectric conversion with a variable exposure time, and an accumulation unit that accumulates the pixel signal generated by the imaging element, the method including: causing the imaging element to repeatedly generate the pixel signal through the photoelectric conversion for each of the divided exposure time periods obtained by dividing a necessary exposure time which is necessary for imaging an image into multiple time periods at intervals of a predetermined time within an imaging time of one frame image; and, causing the accumulation unit to accumulate the pixel signal generated by the imaging element and output the pixel signal accumulated in the necessary exposure time.

According to still another embodiment of the present technology, there is provided an imaging apparatus including: an imaging element that generates a pixel signal through photoelectric conversion with a variable exposure time; and an accumulation unit that accumulates the pixel signal generated by the imaging element, in which the imaging element repeatedly generates the pixel signal through the photoelectric conversion for each of the divided exposure time periods obtained by dividing a necessary exposure time which is necessary for imaging an image into multiple time periods at intervals of a predetermined time within an imaging time of one frame image, and the accumulation unit accumulates the pixel signal generated by the imaging element and outputs the pixel signal accumulated in the necessary exposure time.

According to the embodiments of the present technology, a pixel signal is generated by an imaging element through photoelectric conversion with a variable exposure time, the pixel signal generated by the imaging element is accumulated by an accumulation unit, the pixel signal is repeatedly generated by the imaging element through the photoelectric conversion for each of the divided exposure time periods obtained by dividing a necessary exposure time which is necessary for imaging an image into multiple time periods at intervals of a predetermined time within an imaging time of one frame image, and the pixel signal generated by the imaging element is accumulated by the accumulation unit and the pixel signal accumulated in the necessary exposure time is output.

According to the embodiments of the present technology, it is possible to capture an optimal image even when a diaphragm is freely set by a user without considering the amount of incident light.

### BRIEF DESCRIPTION OF THE DRAWINGS

FIG. 1 is a diagram describing a configuration of an embodiment of an imaging apparatus to which the present technology is applied;

FIG. 2 is a diagram describing a specific configuration example of an imaging element of FIG. 1;

FIG. 3 is a diagram describing a configuration example of a memory unit of FIG. 2;

FIG. 4 is a diagram describing a configuration example of a light receiving element constituting a light receiving element array of FIG. 2;

FIG. 5 is a timing chart describing an operation of the imaging element provided with the light receiving element array of FIG. 2;

FIG. 6 is a flowchart describing image processing;

FIG. 7 is a diagram describing an operation of the imaging element in the image processing;

FIG. 8 is a diagram describing the image processing;

FIG. 9 is a flowchart describing exposure control processing;

FIG. 10 is a diagram describing the exposure control processing;

FIG. 11 is a diagram describing the exposure control processing;

FIG. 12 is a diagram describing a modification example of the light receiving element constituting the light receiving element array of FIG. 2;

FIG. 13 is a timing chart describing an operation of the imaging element provided with the light receiving element array of FIG. 12; and

FIG. 14 is a diagram describing a configuration example of a general-purpose personal computer.

### DETAILED DESCRIPTION OF EMBODIMENTS

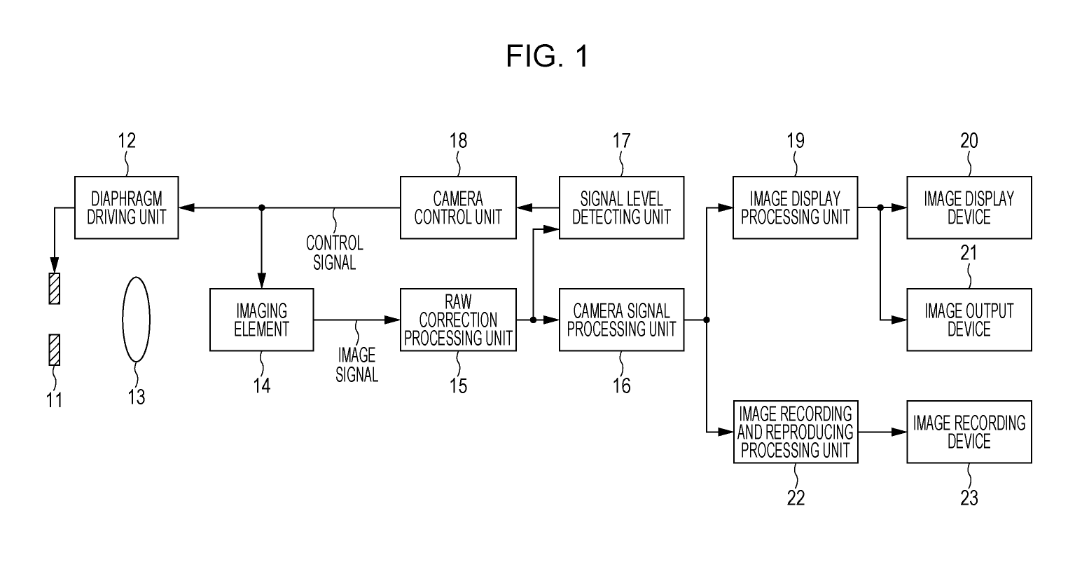

Configuration example of imaging apparatus FIG. 1 is a block diagram showing a configuration example of an imaging apparatus to which the present technology is applied.

The imaging apparatus of FIG. 1 includes a diaphragm mechanism unit 11, a diaphragm driving unit 12, a lens portion 13, an imaging element 14, a RAW correction processing unit 15, a camera signal processing unit 16, a signal level detecting unit 17, a camera control unit 18, an image display processing unit 19, an image display device 20, an image output device 21, an image recording and reproducing processing unit 22, and an image recording device 23.

The diaphragm mechanism unit 11 is a mechanism which operates to vary the diameter of a diaphragm opening portion by moving a plurality of blade-like mechanisms and adjusts the amount of light incident to the imaging element 14 through an operation for changing the diameter of an opening portion by a control signal from the diaphragm driving unit 12.

The lens portion 13 is formed of a lens group constituting an imaging optical system, and performs focus adjustment, and zoom adjustment if necessary.

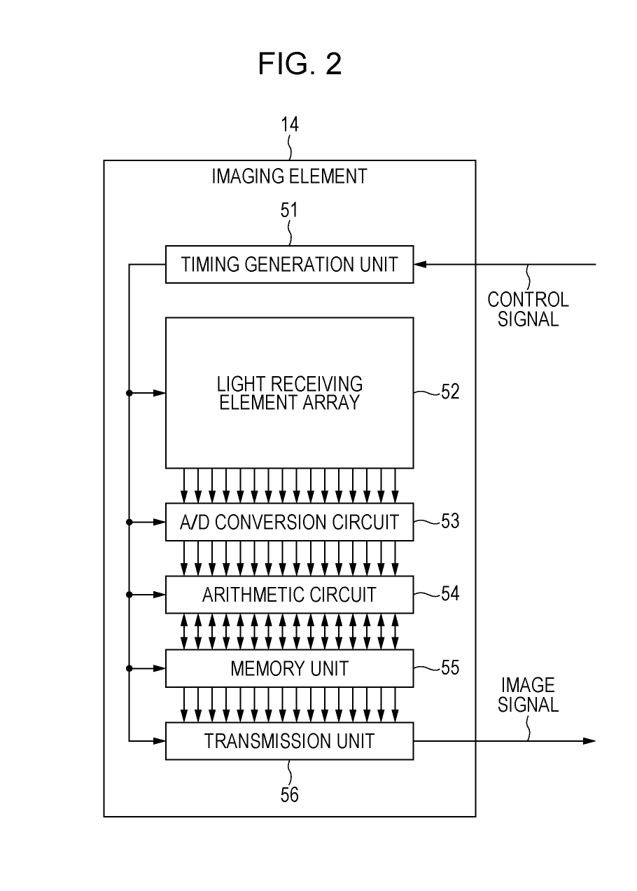

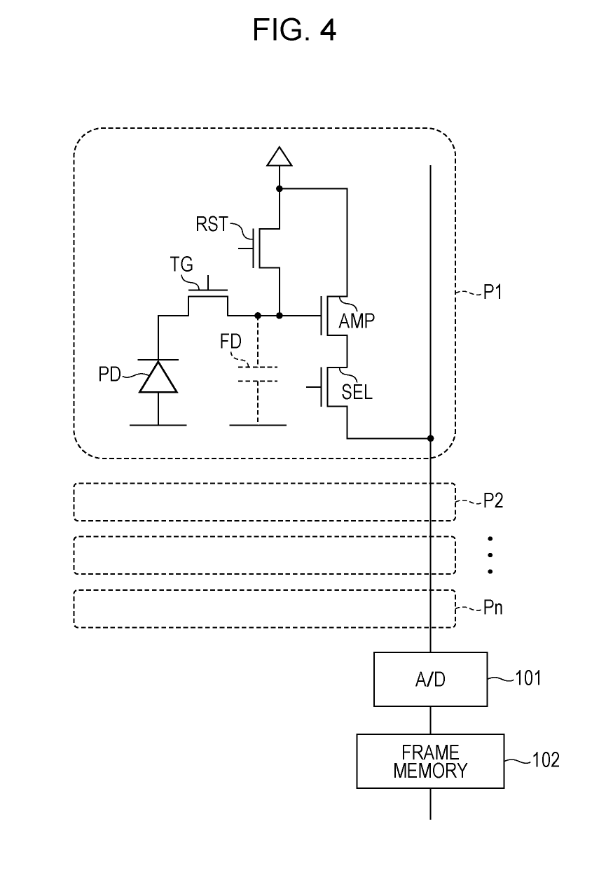

The imaging element 14 performs photoelectric conversion on light focused by the lens portion 13 using light receiving elements P1 to Pn (FIG. 4) arranged in a two-dimensional shape on the light receiving element array (FIG. 2), generates a pixel signal by converting light into an electrical signal, and outputs the pixel signal to the RAW correction processing unit 15 as an image signal formed of a pixel signal of a plurality of pixels. In addition, the internal structure of the imaging element 14 will be described in detail with reference to FIG. 2.

The RAW correction processing unit 15 corrects production tolerance of the image quality in a plane with regard to a pixel defect or a strain due to the lens portion 13 of the image signal output from the imaging element 14 and adjusts a black level and a white level according to a level diagram of a subsequent signal processing. The RAW correction processing unit 15 corrects the production tolerance of the image quality and supplies the image signal in which the black level and the white level are adjusted to the camera signal processing unit 16 and the signal level detecting unit 17.

The camera signal processing unit 16 performs camera signal processing such as pixel interpolation processing, color correction processing, edge correction, gamma correction, and resolution conversion with respect to the image signal supplied from the RAW correction processing unit 15 and outputs the image signal to the image display processing unit 19 and the image recording and reproducing processing unit 22.

The signal level detecting unit 17 supplies information such as an integral value of the entire screen, a signal level of the brightest portion, and a histogram showing distribution of the signal level to the camera control unit 18 by calculating the signal level of each pixel signal constituting image signals in a predetermined effective area.

The camera control unit 18 sets a divided exposure time at intervals of a predetermined time to obtain an optimum the signal level of the image signal based on information such as a current image signal supplied from the signal level detecting unit 17, a current state (F value) of a iris (opening degree of a diaphragm), the shutter speed, a gain, and the number of times of division of the exposure time, and performs feedback control by supplying a control signal to the diaphragm driving unit 12 and the imaging element 14. Further, the camera control unit 18 can perform a manual operation for feedback based on the iris, shutter speed, and gain intentionally set by the user. Setting of the divided exposure time will be specifically described later.

The image display processing unit 19 generates, based on an image signal supplied from the camera signal processing unit 16 and the image recording and reproducing processing unit 22, an image signal for display on the image display device 20 and an image signal for an output by the image output device 21.

The image display device 20 is configured of, for example, a liquid crystal display (LCD) or an organic electroluminescence (EL), and displays a camera-through image during imaging and a reproduced image of an image recorded in the image recording device 23.

The image output device 21 has a data format in conformity with a general video output standard such as High Definition Multimedia Interface (HDMI, registered trademark) and a connector, and outputs the camera-through image during imaging and the reproduced image recorded on the image recording device 23 to an external television or the like.

The image recording and reproducing processing unit 22 performs a compression encoding process on the image signal supplied from the camera signal processing unit 16 using an encoding system of an image such as a Moving Picture Experts Group (MPEG), performs a decompression decoding process on the encoded data of the image supplied from the image recording device 23, and outputs the data to the image display processing unit 19.

The image recording device 23 is a randomly accessible medium such as a semiconductor memory, for example, a Hard Disk Drive (HDD) or a flush memory, or an optical disk such as a Digital Versatile Disk (DVD), and is a continuously accessible medium such as a Digital Video (DV) tape, and records or reads an image signal on which the compression encoding process is performed.

Configuration Example of Imaging Element

Next, the configuration example of the imaging element 14 will be described in detail with reference to FIG. 2.

The imaging element 14 includes a timing generation unit 51, a light receiving element array 52, an Analog/Digital (A/D) conversion circuit 53, an arithmetic circuit 54, a memory unit 55, and a transmission unit 56.

The timing generation unit 51 supplies a timing control signal controlling operation timing of the respective blocks of the imaging element 14 based on the control signal supplied by the camera control unit 18.

The light receiving element array 52 is an aggregate of the light receiving elements P1 to Pn arranged in a two-dimensional shape formed of rows or columns. The light receiving element array 52 sequentially transfers the electric signal generated through photoelectric conversion caused by light being received by respective light receiving elements P1 to Pn arranged in a two-dimensional shape to the A/D conversion circuit 53 as a pixel signal for each column.

The A/D conversion circuit 53 converts a pixel signal formed of an analog signal which is output from the light receiving element array into a pixel signal of a digital signal for each column. The A/D conversion circuit 53 is configured of a follow-up comparison type A/D converter or the like, sequentially compares a counter value that counts up by one digital value per one clock with an analog input signal, stops the counter value when the value finds a match by a comparator, and outputs the value as a pixel signal formed of a digital signal.

The arithmetic circuit 54 writes a signal from the A/D conversion circuit 53 directly on the memory unit 55 to be accumulated or adds the signal from the A/D conversion circuit 53 to a pixel signal accumulated in the memory unit 55 and the result is accumulated in the memory unit 55 again.

The memory unit 55 performs an operation of reading out a signal to the arithmetic circuit 54, and an accumulating operation of writing the arithmetic result of the arithmetic circuit 54, and a transferring operation of sequentially sending the signal to the transmission unit 56 based on the timing control signal supplied from the timing generation unit 51.

The transmission unit 56 transfers a plurality of pixel signals read from the memory unit 55 to the RAW correction processing unit 15 (FIG. 1) as image signals according to the control signal from the timing generation unit 51.

Configuration Example of Memory Unit

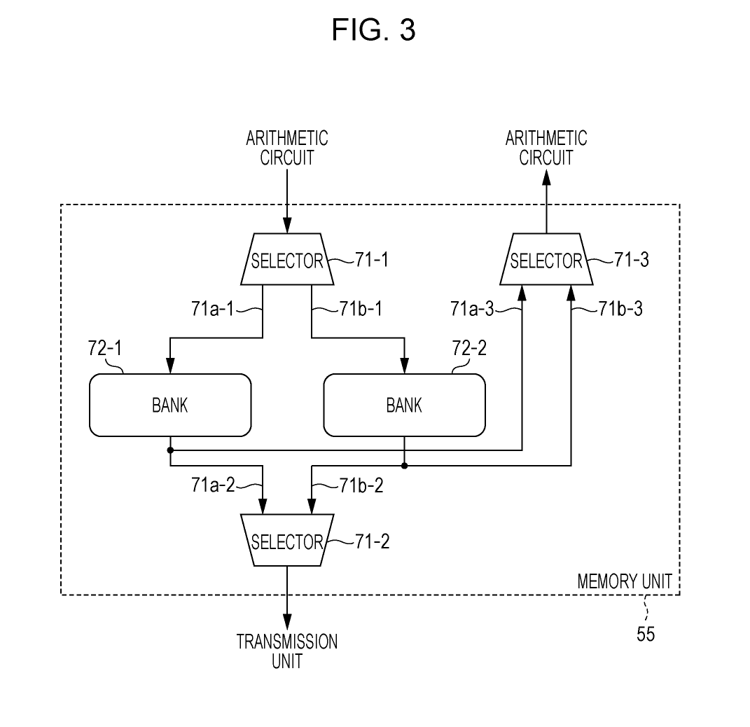

Next, the configuration example of the memory unit 55 will be described with reference to FIG. 3. The memory unit 55 includes selectors 71-1 to 71-3, and banks 72-1 and 72-2. The memory unit 55 accumulates the pixel signal necessary to be stored while alternatively switching the banks 72-1 and 72-2 for each frame by controlling the selectors 71-1 to 71-3. The selectors 71-1 to 71-3 include terminals 71a-1 to 71a-3 and 71b-1 to 71b-3, respectively.

First, in a first state, the selector 71-1 outputs the pixel signal supplied from the arithmetic circuit 54 from a terminal 71a-1, and accumulates the signal in the bank 72-1. At this time, the selector 71-3 reads the pixel signal accumulated in the bank 72-1 from a terminal 71a-3 and supplies the signal to the arithmetic circuit 54. Further, in the first state, in a case where a pixel signal for one previous frame is accumulated in the bank 72-2, the selector 71-2 supplies the pixel signal accumulated in the bank 72-2 from the terminal 71b-2 to the transmission unit 56.

Moreover, when a pixel signal for one subsequent frame is received, the first state is transitioned to a second state. In the second state, the selector 71-1 outputs the pixel signal, which is supplied from the arithmetic circuit 54, from the terminal 71b-1 and accumulates the signal in the bank 72-2. At this time, the selector 71-3 reads the pixel signal accumulated in the bank 72-2 from the terminal 71b-3 and supplies the signal to the arithmetic circuit 54. Moreover, in the second state, in a case where a pixel signal for one previous frame is accumulated in the bank 72-1, the selector 71-2 supplies the pixel signal accumulated in the bank 72-1 from the terminal 71a-2 to the transmission unit 56.

In addition, when the pixel signal for one subsequent frame is received, the second state is transitioned to the first state, and the transition of states is alternately repeated for each frame.

Configuration example of light receiving element Next, the configuration example of the light receiving element constituting the light receiving element array 52 will be described with reference to FIG. 4. Further, the light receiving element shown in FIG. 4 has a normal format configured of four transistors, but may have another configuration.

The light receiving elements P1 to Pn have the same configurations as each other, and are configured of a photodiode PD, a transfer transistor TG, a floating diffusion FD, a reset transistor RST, an amplifier transistor AMP, and a selection transistor SEL. Further, an A/D conversion circuit 101 is provided on a transfer line of the light receiving elements P1 to Pn arranged in the vertical direction. Further, the A/D conversion circuit 53 is an aggregate of a plurality of A/D conversion circuits 101 arranged in the column direction.

In the photodiode PD, a cathode is connected to the transfer transistor TG, the charge which is an electric signal generated through photoelectric conversion according to light receiving is accumulated, and the charge is output to the floating diffusion FD according to the opening and closing of the transfer transistor TG.

The transfer transistor TG constitutes a transfer gate by opening and closing based on the transfer signal and transfers the charge accumulated in the photodiode PD to the floating diffusion FD.

The floating diffusion FD is a capacitor area formed with wiring capacity, accumulates the charge transferred from the photodiode PD through the transfer transistor TG, and supplies the charge to a gate of the amplifier transistor AMP.

The reset transistor RST configures a reset gate by opening and closing based on a reset signal and discharges the charge accumulated in the floating diffusion FD when turned ON. Further, the reset transistor RST discharges the charge accumulated in the floating diffusion FD and the charge accumulated in the photodiode PD to realize a reset operation when turned ON together with the transfer transistor TG.

The amplifier transistor AMP amplifies the power supply voltage based on the charge amount to be output as a pixel signal by opening and closing when the charge accumulated in the floating diffusion FD is input to the gate.

The selection transistor SEL constitutes a select gate by opening and closing based on a selection signal and outputs the pixel signal amplified by the amplifier transistor AMP to the A/D conversion circuit 101 when turned ON.

The A/D conversion circuit 101 outputs the pixel signal which is converted into a digital signal to a frame memory 102. The frame memory 102 accumulates a pixel signal of one frame and outputs the signal as a pixel signal.

Further, in FIG. 4, one A/D conversion circuit 101 is provided for each column, but one A/D conversion circuit 101 is provided for a plurality of columns or a plurality of A/D converters are provided in one column in some cases, and it is possible to speed up processing by increasing the configuration ratio of the A/D converter with respect to the column.

In Regard to Exposure Timing

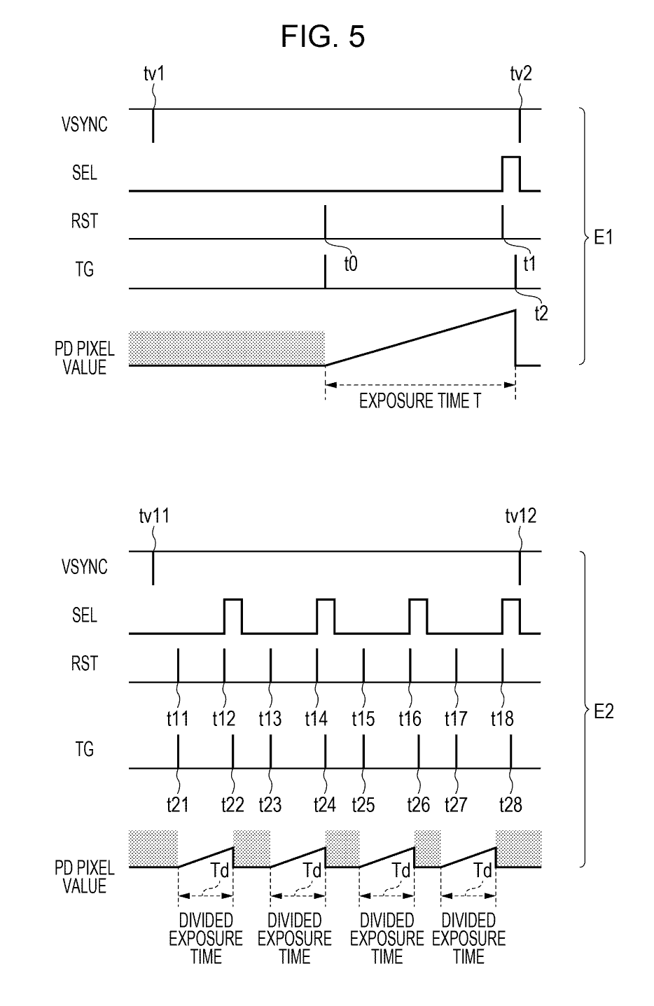

Next, the exposure timing in the imaging element 14 will be described with reference to the timing chart of FIG. 5.

First, the exposure timing in a normal operation will be described with reference to the timing chart shown as an operation E1. Further, in FIG. 5, both of operations E1 and E2 represent the timing of a vertical synchronization signal SYNC, a selection signal SEL, a reset signal RST, and a transfer signal TG, and a pixel value (PD pixel value) accumulated in the photodiode PD from the upper side, and the horizontal axis represents time. Therefore, at the timing in which the selection signal SEL, the reset signal RST, and the transfer signal TG are Hi, the selection transistor SEL, the reset transistor RST, and the transfer transistor TG in FIG. 3 are turned ON, but the respective signals are turned OFF at other timing.

That is, when the vertical synchronization signal VSYNC is generated at a time tv1, a period from the timing to the timing of a time tv2 at which the vertical synchronization signal VSYNC is generated is considered as an imaging period of one frame. In a time t0 after a predetermined time is passed from the time tv1 at which the vertical synchronization signal VSYNC is generated, the reset transistor RST and the transfer transistor TG of FIG. 3 are turned ON at the same time, and the photodiode PD and the floating diffusion FD are reset at the same time by the reset transistor RST and the transfer transistor TG being turned OFF immediately after the ON state to be set to a state in which accumulation of the charge can be initiated. Accordingly, as shown in the time t0 to the time t2, the charge generated through the photoelectric conversion is accumulated as the pixel signal in the photodiode PD according to the time by light reception occurring from the time t0 to the time t2.

In addition, here, the predetermined time of the above-described times tv1 to t0 is considered as a period other than the exposure time in the synchronization period of the vertical synchronization signal VSYNC in the times tv1 to tv2.

Next, as shown in the second stage of FIG. 5, in the time t1 near the time t2 at which a preset exposure time T has been passed, the selection transistor SEL is turned ON, a pixel signal formed of an analog signal is set to be converted into a digital signal by the A/D conversion circuit 101, the reset transistor RST is temporarily turned ON, the charge gradually accumulated in the floating diffusion FD is reset again by a dark current, and the pixel signal at this time is converted into a digital signal as a reset value.

Next, at the time t2, the transfer transistor TG is turned ON, and the charge accumulated in the photodiode PD is transferred to the floating diffusion FD to be converted into a digital signal. Switch noise (kT/C noise) applied at the time when the reset transistor RST is turned OFF is cancelled through subtraction (CDS) of two values obtained in states in which the transfer transistor TG is turned ON and OFF so that an excellent pixel signal with less noise can be obtained.

Next, the exposure timing when the pixel signal is read with the exposure time T being divided into four time periods will be described with reference to the operation E2. That is, it is possible to finely divide the exposure time T into a time to be unexposed and a time to be exposed by dividing the exposure time T in a time Tv11 to a time Tv12 set by the vertical synchronization signal VSYNC into four time periods and by performing the above-described typical readout sequence in each divided exposure time Td. In other words, by increasing the number of times of division necessary for imaging for one image, it is possible to continuously perform exposure microscopically and to shorten the total exposure time taken for imaging for one image.

Moreover, here, the above-described typical readout sequence is a sequence in which the selection transistor SEL is turned ON, the reset value of the floating diffusion FD is converted into the digital signal by turning ON the reset transistor RST, and the pixel signal is held by the floating diffusion FD to be converted into the digital signal by turning ON the transfer transistor TG, and then the pixel signal is acquired through acquisition of the difference.

More specifically, when the vertical synchronization signal VSYNC is generated at a time tv11, a period from the timing to the timing of a time tv12 at which the vertical synchronization signal VSYNC is generated is considered as an imaging period of one frame. In a time t11 (=t21) at which a predetermined time (time to be unexposed) is passed from the time tv11 at which the vertical synchronization signal VSYNC is generated, the reset transistor RST and the transfer transistor TG of FIG. 3 are turned ON at the same time, and the photodiode PD and the floating diffusion FD are reset at the same time by the reset transistor RST and the transfer transistor TG being turned OFF immediately after the ON state to be set to a state in which accumulation of the charge can be initiated.

Accordingly, as shown in the divided exposure time Td represented by a time t11 to a time t12, a pixel signal is generated through the photoelectric conversion in the photodiode PD by light reception occurring from the time t11 to a time t12 and the pixel signal is accumulated according to the time.

Next, at the time t12 near a time t22 at which the divided exposure time Td which is a quarter of the preset and necessary exposure time T passes, the selection transistor SEL is turned ON, a pixel signal formed of an analog signal is set to be converted into a digital signal by the A/D conversion circuit 101, the reset transistor RST is temporarily turned ON, the charge gradually accumulated in the floating diffusion FD is reset again by the dark current, and the reset value at this time is converted into a digital signal.

Next, at the time t22, the transfer transistor TG is turned ON, and the charge accumulated in the photodiode PD is transferred to the floating diffusion FD to be converted into a digital signal. The switch noise (kT/C noise) applied at the time when the reset transistor RST is turned OFF is cancelled through subtraction (CDS) of two values obtained in states in which the transfer transistor TG are turned ON and OFF so that an excellent pixel signal with less noise can be obtained.

In the description below, by repeatedly performing a process which is the same as the process of the time tv1 to time t22 at times t22 to t24, t24 to t26, and t26 to t28, the pixel signal acquired by the divided exposure time Td which is a quarter of the necessary exposure time is accumulated four times. Accordingly, a pixel signal corresponding to the necessary exposure time T can be obtained by integrating the four pixel signals in the divided exposure time Td.

As a result, in a period (period of the time tv11 to the time tv12 in which the vertical synchronization signal VSYNC is generated) necessary for acquiring an image of one frame, it is possible to divide the necessary exposure time T as the divided exposure time Td which is a period for exposure with predetermined time intervals. Accordingly, in the period necessary for acquiring an image of one frame, it is possible to acquire a pixel signal in which the exposure timing is dispersed as a whole unit without changing the exposure time T which is the total exposure time, and thus, it is possible to suppress jerkiness while the total exposure time represented by the necessary exposure time T is shortened. As a result, even when the shutter speed is increased, it is possible to image an image in which the generation of jerkiness is suppressed.

Image Processing

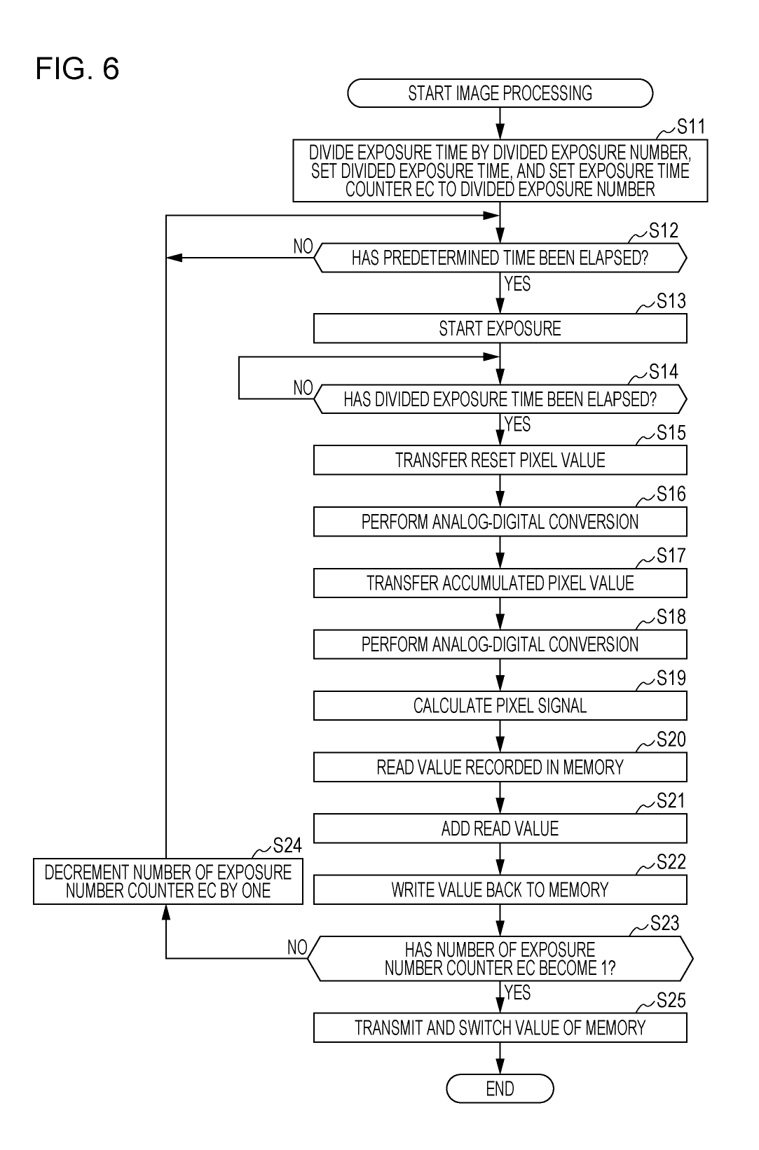

Next, the image processing will be described with reference to the flowchart of FIG. 6.

In Step S11, the camera control unit 18 controls the diaphragm mechanism unit 11 to have a set opening degree by supplying a control signal to the diaphragm driving unit 12 based on the signal level of the pixel signal of a previous frame supplied from the signal level detecting unit 17, and the divided exposure time and a predetermined time to be unexposed which is the interval of the divided exposure time are set with respect to the timing generation unit 51 by calculating the necessary exposure time according to the shutter speed and dividing the exposure time by the number of times of division exposure.

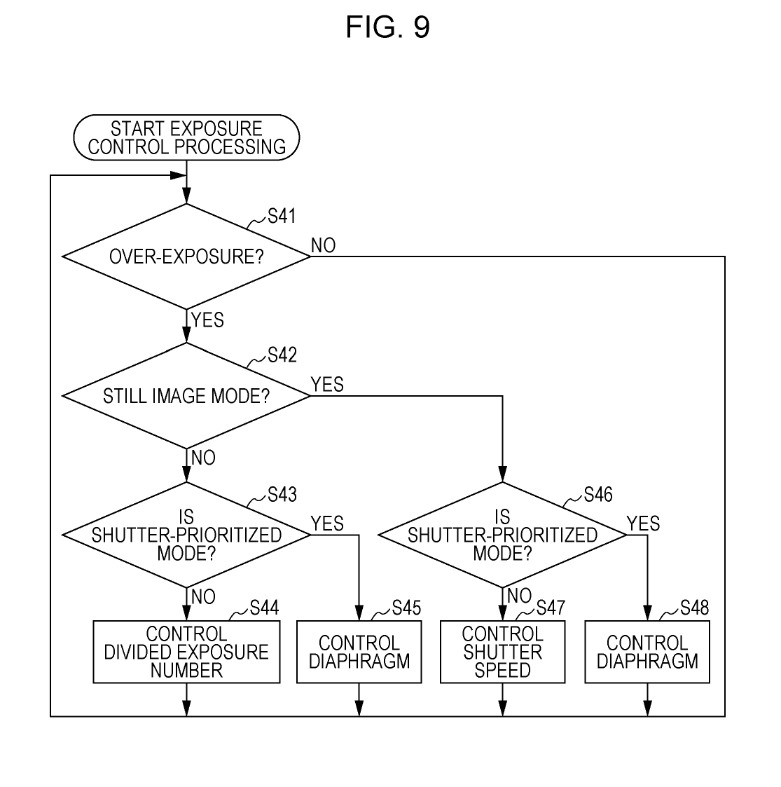

At this time, for example, in a case where the imaging time of one frame of an image which is an interval of the vertical synchronization signal VSYNC is divided into four time periods, the camera control unit 18 sets the exposure time counter EC to 4, and a divided exposure time obtained by dividing the exposure time into four time periods and the time to be unexposed other than the divided exposure time are allocated in the time divided into four time periods. Further, the camera control unit 18 sets an appropriate shutter speed and an appropriate opening degree by performing a process described later with reference to FIG. 9 when the necessary exposure time is calculated. Further, in the initial process, since the previous pixel signal is not present, a predetermined signal level may be set as a default value.

In Step S12, the timing generation unit 51 determines whether a predetermined time has passed as an interval of the divided exposure time. More specifically, the timing generation unit 51 determines whether a predetermined time to be unexposed is passed which is an interval of the divided exposure time shown from the time tv11 to t11 described with reference to the operation E2 of FIG. 5, and the process is advanced to Step S13 when determination is made that the predetermined time has passed.

In Step S13, the timing generation unit 51 generates and supplies a timing signal with respect to each light receiving element P of the light receiving element array 52 according to the setting of the number of times of division exposure and the exposure time from the camera control unit 18. Further, each of the light receiving elements P of the light receiving element array 52 initiates exposure according to the timing signal.

More specifically, the timing generation unit 51 releases the remaining charge to be reset by controlling the reset transistor RST and the transfer transistor TG to be ON simultaneously for an extremely short period of time based on the set value from the camera control unit 18. The charge accumulated in the photodiode PD and the floating diffusion FD is reset due to the process and the charge accumulation is made possible.

In Step S14, the timing generation unit 51 determines whether the time shown in the time t11 to the time t12 described with reference to the operation E2 of FIG. 5 has passed, and the same process is repeated until the timing generation unit 51 determines that the time has passed. The process is advanced to Step S15 when the determination is made that the time has passed.

In Step S15, the timing generation unit 51 controls the selection transistor SEL to be ON and makes the charge to be transferable to the A/D conversion circuit 101. Further, the timing generation unit 51 controls the reset transistor RST to be ON for an extremely short period of time, amplifies a signal by the charge accumulated in the floating diffusion FD due to the dark current through the amplifier transistor AMP, and transfers the signal to the A/D conversion circuit 101 as a reset signal. That is, the pixel value in a reset state is transferred.

In Step S16, the A/D conversion circuit 53 (A/D conversion circuit 101) converts the supplied reset signal from the analog signal to the digital signal and holds the converted signal in the A/D conversion circuit 53 as a negative value. That is, by this process, the reset signal formed of only the switch noise generated due to the dark current is held in the A/D conversion circuit 53 as a negative value.

In Step S17, the timing generation unit 51 controls the transfer transistor TG to be ON and transfers the charge accumulated in the photodiode PD to the floating diffusion FD. At this time, since the selection transistor SEL is ON, the charge accumulated in the floating diffusion FD is transferred to the A/D conversion circuit 101 as a pixel signal amplified through the amplifier transistor AMP. That is, the accumulated pixel value is transferred.

In Step S18, the A/D conversion circuit 53 (A/D conversion circuit 101) converts the supplied pixel signal into a digital signal from an analog signal as a positive value. That is, the pixel signal corresponding to the charge accumulated in the photodiode PD including the switch noise generated due to the dark current is converted as a positive value by this process.

In Step S19, the A/D conversion circuit 53 (A/D conversion circuit 101) calculates the pixel signal which makes the switch noise be cancelled by continuously converting the reset signal held as a negative value formed of only the switch noise and the A/D converted pixel signal as a positive value corresponding to the charge accumulated in the photodiode PD including the switch noise.

In Step S20, the arithmetic circuit 54 reads the pixel signal stored in the memory unit 55. Further, in the case of first exposure, since the pixel signal stored in the memory unit 55 is not present, the process of Step S20 may be skipped.

In Step S21, the arithmetic circuit 54 adds the pixel signal read from the memory unit 55 to the pixel signal converted in the A/D conversion circuit 53 (A/D conversion circuit 101). In a case of first exposure, since the pixel signal stored in the memory unit 55 is not present, the process of Step S21 may be also skipped similarly to the process of Step S20.

In Step S22, the arithmetic circuit 54 writes the pixel signal which is the result of addition between the pixel signal read from the memory unit 55 and the pixel signal converted in the A/D conversion circuit 53 (A/D conversion circuit 101) back to the memory unit 55 to be stored.

In regard to the process of Step S22, in a case where exposure is the first time exposure and the processes of Steps S20 and S21 are skipped, since the pixel signal acquired by calculation is not present, the A/D conversion circuit 53 (A/D conversion circuit 101) transfers the pixel signal directly to the memory unit 55 to be stored in the bank 72-1 or 72-2 without transferring the signal through the arithmetic circuit 54.

In Step S23, the timing generation unit 51 determines whether the exposure time counter EC is 1, that is, whether the process is repeated by the number of times of division exposure. In Step S23, in a case where the value indicated by the exposure time counter EC does not reach the number of times of division exposure, that is, in a case where the exposure time counter EC is not 1, the process is advanced to Step S24.

In Step S24, the timing generation unit 51 decrements the exposure time counter EC by 1 and the process is returned to Step S12. That is, in Step S23, the processes of Steps S12 to S24 are repeated by the number of times of division exposure until the exposure time counter EC becomes 1. Further, in Step S23, when the exposure time counter EC becomes 1 and it is considered that the processes are repeated by the number of times of division exposure, the process is advanced to Step S25.

In Step S35, the timing generation unit 51 instructs the banks 72-1 and 72-2 in the memory unit 55 to be switched. According to the instruction, the selectors 71-1 to 71-3 switch each of the terminals 71a-1 to 71a-3 and 71b-1 to 71b-3 from the state immediately before, and send data of the bank in which division exposure is completed to the transmission unit 56, and then switch the bank in which the transfer to the transmission unit is completed to be used for the division exposure operation of the subsequent frame. Further, simultaneously with a main sequence, the control signal that transfers the pixel signal stored in the memory unit 55 of the previous frame in which the division exposure is completed is supplied and the transmission unit 56 is controlled such that the pixel signal for one frame is read and then transmitted.

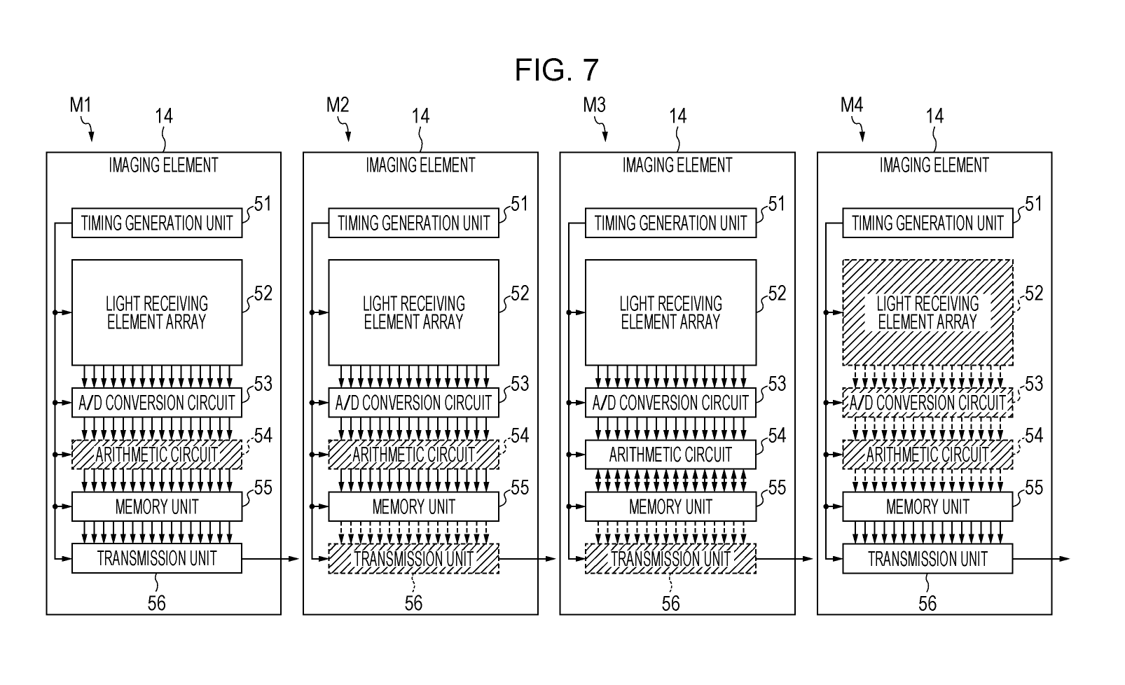

That is, in general, as shown in a state M1 of FIG. 7, an appropriate exposure time is set as an exposure time by the timing generation unit 51, and the charge which becomes a pixel signal is accumulated in the light receiving element array 52 in the imaging element 14. Further, the pixel signal is read from the light receiving element array 52, converted to the digital signal by the A/D conversion circuit 53, the converted pixel signal passes through the arithmetic circuit 54 to be supplied to the memory unit 55, and the transmission unit 56 outputs the pixel signal stored in the memory unit 55. Further, in FIG. 7, oblique lines are added in the configuration in which the operation is stopped among the timing generation unit 51 to the transmission unit 56.

Meanwhile, in the case of the process described with reference with the flowchart of FIG. 6, for example, the process shown in a state M2 of FIG. 7 is performed by the processes of Step S12 to S22 when the number of times of division exposure is four. That is, in the initial divided exposure time obtained by dividing the appropriate exposure time into four time periods, the charge is accumulated in the light receiving element array 52, and the pixel signal converted into the digital signal by the A/D conversion circuit 53 is accumulated in the memory unit 55.

In addition, at the time subsequent to the initial divided exposure time obtained by dividing the exposure time into four time periods, the charge is accumulated in the light receiving element array 52 by the processes of Step S22 to S22 as shown in a state M3 of FIG. 7, and the process in which the pixel signal converted into the digital signal by the A/D conversion circuit 53 and the pixel signal accumulated in the memory unit 55 are added to each other, and then the result is accumulated in the memory unit 55 again is repeated.

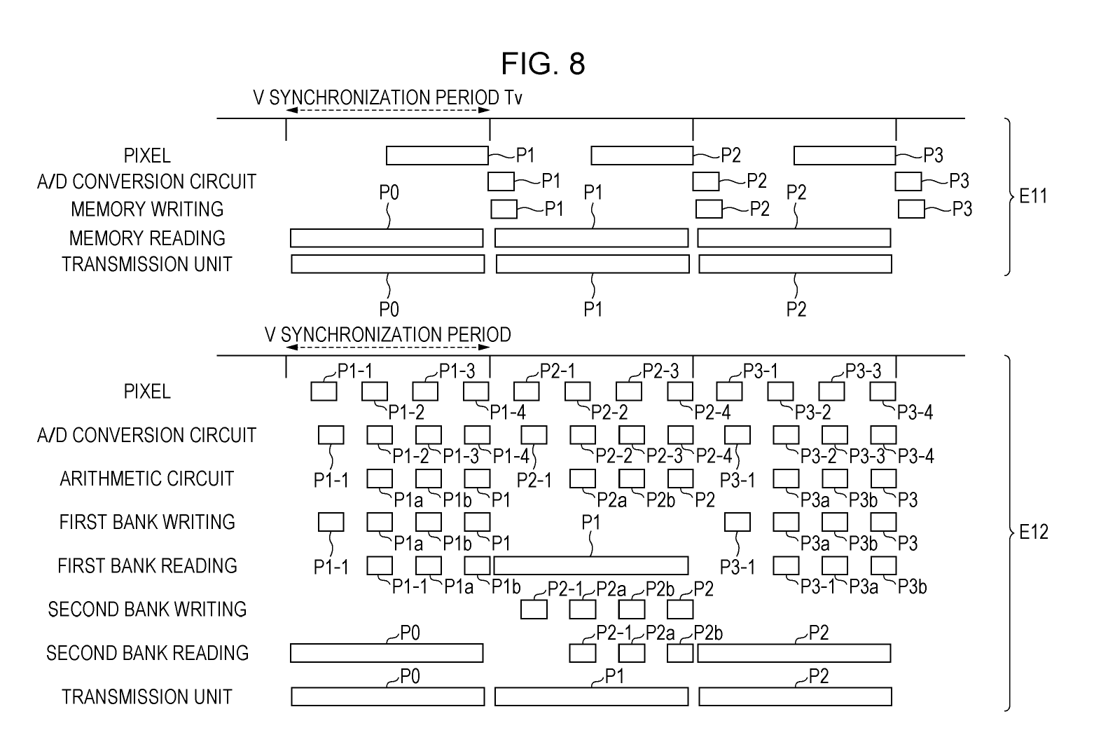

When the exposure time is completed, as shown in a state M4 of FIG. 7, the pixel signal stored in the memory unit 55 is transmitted by the transmission unit 56 through the process of Step S25. That is, more specifically, a process shown in the timing chart of FIG. 8 is realized by the process described above. Further, in FIG. 8, an example of dividing the necessary exposure time into four time periods is described. Moreover, in an operation E11 in the upper stage of FIG. 8, processes in the related art are shown, and in an operation E12, a process to which the present technology is applied is shown.

In addition, in an operation E11, the vertical synchronization signal VSYNC, a period (pixel) for which the pixel signal is accumulated in the light receiving element array 52, a period (A/D conversion circuit) in which an analog-digital conversion process is performed by the A/D conversion circuit 53, a period (writing in the memory) of writing the pixel signal in the memory unit 55, a period (reading out memory) for reading of the pixel signal from the memory unit 55, and a period (transmission unit) for transferring the pixel signal accumulated in the memory unit 55 by the transmission unit 56 are respectively shown from the upper side.

In addition, in the operation E12, the vertical synchronization signal VSYNC, a period (pixel) for which the pixel signal is accumulated in the light receiving element array 52, a period (A/D conversion circuit) in which an analog-digital conversion process is performed by the A/D conversion circuit 53, a period (arithmetic circuit) integrating the pixel signal from the A/D conversion circuit 53 and the pixel signal read by the memory unit 55 by the arithmetic circuit 54, a period (first bank writing) for writing the pixel signal in the bank 72-1 of the memory unit 55, a period (first bank reading) for reading the pixel signal from the bank 72-1 of the memory unit 55, a period (second bank writing) for writing the pixel signal in the bank 72-2 of the memory unit 55, a period (second bank reading) for reading the pixel signal from the bank 72-2 of the memory unit 55, and a period (transmission unit) for transferring the pixel signal accumulated in the memory unit 55 by the transmission unit 56 are respectively shown from the upper side. Further, in both operations, the horizontal axis represents time.

In other words, in the related art, as shown in the fifth and sixth stages from the upper side in the operation E11 of FIG. 8, in the entire periods of the synchronization period (V synchronization period Tv) of the initial vertical synchronization signal VSYNC, the pixel signal of an image P0 which is a previous frame is read from the memory unit 55 by the transmission unit 56 to be transmitted at a predetermined data rate. Further, as shown in the uppermost stage in the operation E11 of FIG. 8, the pixel signal of an image P1 is accumulated in the light receiving element array 52 as shown in the second stage in the operation E11 after a predetermined time is passed after the synchronization period (V synchronization period Tv) of the initial vertical synchronization signal VSYNC is started.

Further, as shown in the third and fourth stages of the operation E11, when the synchronization period (V synchronization period Tv) of the second vertical synchronization signal VSYNC is started, the pixel signal of the image P1 accumulated in the synchronization period (V synchronization period Tv) of the initial vertical synchronization signal VSYNC is converted into the digital signal by the A/D conversion circuit 53 and then recorded in the memory unit 55. At the same time, as shown in the fifth and sixth stages of the operation E11, the transmission unit 56 transmits the pixel signal P1 written in the memory unit 55 at a predetermined data rate. In addition, after the predetermined time is passed, the pixel signal of the image P2 is accumulated by the light receiving element array 52.

In the synchronization period (V synchronization period Tv) of the third vertical synchronization signal VSYNC, a process which is the same as the process in the synchronization period (V synchronization period Tv) of the second vertical synchronization signal VSYNC is performed with respect to the pixel signal of an image P3, and then the same process is repeatedly performed. Meanwhile, a process shown in the operation E12 is realized by the process described with reference to the flowchart of FIG. 6.

As shown in the uppermost stage in the operation E12, a pixel signal P1-1 of an initial divided exposure time obtained by dividing the necessary exposure time of the image P1 into four time periods is accumulated (Step S13) in the light receiving element array 52 as shown in the second stage in the operation E12 after a predetermined time is passed after the synchronization period (V synchronization period Tv) of the initial vertical synchronization signal VSYNC is started.

As shown in the third stage of the operation E12, the pixel signal P1-1 accumulated in the light receiving element array 52 is converted into the digital signal by the A/D conversion circuit 53 (Steps S15 to S19).

As shown in the fifth stage in the operation E12, the pixel signal P1-1 is stored in the bank 72-1 (first bank) of the memory unit 55.

Further, as shown in the second stage of the operation E12, when a predetermined time is passed from the timing at which the pixel signal P1-1 is accumulated, a pixel signal P1-2 of the second-divided exposure time obtained by dividing the necessary exposure time of the image P1 into four time periods is accumulated in the light receiving element array 52 (Step S13).

As shown in the third stage in the operation E12, the pixel signal P1-2 accumulated in the light receiving element array 52 is converted into the digital signal by the A/D conversion circuit 53 (Steps S15 to S19).

As shown in the sixth stage in the operation E12, the arithmetic circuit 54 reads (Step S20) the pixel signal P1-1 stored in the bank (first bank) 72-1 of the memory unit 55, and generates a pixel signal P1a (Step S21) by performing calculation of adding the pixel signal P1-2 to the pixel signal P1-1 as shown in the third stage in the operation E12. Furthermore, as shown in the fifth stage in the operation E12, the arithmetic circuit 54 writes (Step S22) the calculated pixel signal P1a in the bank (first bank) 72-1 of the memory unit 55.

Moreover, as shown in the second stage in the operation E12, when a predetermined time is passed from the timing at which the pixel signal P1-2 is accumulated, a pixel signal P1-3 of the third-divided exposure time obtained by dividing the necessary exposure time of the image P1 into four time periods is accumulated in the light receiving element array 52 (Step S13).

As shown in the third stage in the operation E12, the pixel signal P1-3 accumulated in the light receiving element array 52 is converted into the digital signal by the A/D conversion circuit 53 (Steps S15 to S19).

As shown in the sixth stage in the operation E12, the arithmetic circuit 54 reads (Step S20) the pixel signal P1a stored in the bank (first bank) 72-1 of the memory unit 55, and generates a pixel signal P1b (Step S21) by performing calculation of adding the pixel signal P1-3 to the pixel signal P1a as shown in the fourth stage in the operation E12. Furthermore, as shown in the fifth stage in the operation E12, the arithmetic circuit 54 writes (Step S22) the calculated pixel signal P1b in the bank (first bank) 72-1 of the memory unit 55.

Hereinafter, in the same manner as the description above, as shown in the second stage of the operation E12, when a predetermined time is passed from the timing at which the pixel signal P1-3 is accumulated, a pixel signal P1-4 of the fourth-divided exposure time obtained by dividing the necessary exposure time of the image P1 into four time periods is accumulated in the light receiving element array 52 (Step S13).

As shown in the third stage from the upper side in the operation E12, the pixel signal P1-4 accumulated in the light receiving element array 52 is converted into the digital signal by the A/D conversion circuit 53 (Steps S15 to S19).

As shown in the sixth stage in the operation E12, the arithmetic circuit 54 reads (Step S20) the pixel signal P1b stored in the bank (first bank) 72-1 of the memory unit 55, and generates a pixel signal P1 (Step S21) by performing calculation of adding the pixel signal P1-4 with the pixel signal P1b as shown in the fourth stage in the operation E12. Furthermore, as shown in the fifth stage in the operation E12, the arithmetic circuit 54 writes the calculated pixel signal P1 in the bank (first bank) 72-1 of the memory unit 55 (step S22).

Further, as shown in the eighth and ninth stages in the operation E12, in the entire periods of the synchronization period (V synchronization period Tv) of the initial vertical synchronization signal VSYNC, the previous pixel signal of the image P0 written in the bank (second bank) 72-2 of the memory unit 55 is read and then transmitted by the transmission unit 56.

Furthermore, as shown in the sixth and ninth stages in the operation E12, in the entire periods of the synchronization period (V synchronization period Tv) of the second vertical synchronization signal VSYNC, the previous pixel signal of the image P1 written in the bank (first bank) 72-1 of the memory unit 55 is read and then transmitted by the transmission unit 56.

Hereinafter, in the same manner as the description above, the pixel signal of the image P2 is generated and then transmitted in the synchronization period of the initial vertical synchronization signal VSYNC in the entire periods of the synchronization period of the second vertical synchronization signal VSYNC, and the pixel signal of the image P3 is generated and then transmitted in the synchronization period of the initial vertical synchronization signal VSYNC in the entire periods of the synchronization period of the third vertical synchronization signal VSYNC.

Moreover, at this time, as shown in the fifth to ninth stages in the operation E12, whenever the synchronization period of the vertical synchronization signal VSYNC is switched, the banks (first bank) 72-1 and (second bank) 72-2 of the memory unit 55 are sequentially switched (Step S25) to be used.

By the process as described above, in the period for imaging an image of one frame, it is possible to disperse the pixel signal generated by the imaging element 14 in the period for imaging an image of one frame to be set by setting the divided exposure time obtained by dividing the necessary exposure time and then by setting the divided exposure time with a predetermined time interval.

As a result, by the pixel signal being configured by integrating the signal imaged in the divided exposure time set to be separated to each other in the period for imaging an image of one frame, it is possible to suppress jerkiness even when the necessary exposure time which is the total exposure time is shortened.

Further, since widening of an optical light collection (airy disk) can be suppressed, a small diaphragm blur which is a phenomenon in which the size of a unit pixel is not collected thereby causing the image to be out of focus can be suppressed.

In addition, since it is possible to generate a pixel signal through repeated accumulation, the saturated amount of the charge to be accumulated by the imaging element 14 may be set as a saturated amount which is several times the number of division. As a result, in a case of imaging a bright scene, it is possible to appropriately image an image with a high dynamic range without mounting an ND filter. Further, since it is possible to image in a state in which ISO sensitivity to be adjusted by decreasing the gain is decreased, imaging with a state in which the diaphragm is set on a release side is possible and imaging with so-called blur and a shallow depth of field is possible even in a bright scene.

Exposure Control Processing

Next, exposure control processing will be described with reference to the flowchart of FIG. 9.

In Step S41, the camera control unit 18 determines whether a signal level of a pixel signal of a previous frame to be supplied from the signal level detecting unit 17 is an optimum level. Here, the optimum level is a signal level which is not overly exposed. In Step S41, in a case where it is determined that the signal level is overly exposed and is not optimum, the process is advanced to Step S42.

In Step S42, the camera control unit 18 determines whether a current image mode is a still image mode of a still image. The imaging apparatus to which the present technology is applied can image one of a still image and a moving image, and each of the image modes is referred to as a still image mode and a moving image mode. In Step S42, for example, in a case where it is determined that the current image mode is not a still image mode but a moving image mode, the process is advanced to Step S43.

In step S43, the camera control unit 18 determines whether the shutter speed is prioritized in operation modes related to the imaging. In the operation modes, there are a shutter speed-prioritized mode in which a diaphragm is adjusted in accordance with the shutter speed and a diaphragm-prioritized mode in which the shutter speed is adjusted in accordance with the diaphragm. In Step S43, for example, in a case where the operation mode is not the shutter-prioritized mode but the diaphragm-prioritized mode, the process is advanced to Step S44.

In Step S44, the camera control unit 18 changes the setting of the divided exposure time into the setting of shortening the total exposure time. That is, due to the over exposure, the setting can be changed into the setting of shortening the exposure time by more increasing the shutter speed. In this case, since the total exposure time becomes shortened, the divided exposure time is shortened with the same ratio. However, since the period generating an image of one frame becomes the synchronization period of the vertical synchronization signal VSYNC, an interval of the period set as the divided exposure time becomes long, accordingly, the period to be unexposed in Steps S12 and S22 becomes long. As a result, in the case where the period set as the divided exposure time is the synchronization period of the vertical synchronization signal VSYNC, the state thereof is set to be more sparse, and the total exposure time is shortened.

Meanwhile, in Step S43, in the case where it is determined that the operation mode is a shutter speed-prioritized mode, the process is advanced to Step S45.

In Step S45, the camera control unit 18 is controlled such that the opening degree of the diaphragm of the diaphragm mechanism unit 11 becomes narrower and the amount of incident light is suppressed.

Further, in Step S42, in the case where it is determined that the image mode is a mode of a still image, the process is advanced to Step S46.

In Step S46, the camera control unit 18 determines whether the operation mode is the shutter speed-prioritized mode. When the operation mode is not the shutter-prioritized mode, that is, the diaphragm-prioritized mode, the shutter speed is controlled in Step S47. Further, in the example, since the process is set to be a process on the premise that the exposure time is not divided in a still image, the total exposure time of the one-time exposure time is set to be short similarly to the process described in the related art.

Meanwhile, in the case where the operation mode is the shutter speed prioritized mode in Step S45, the process is advanced to Step S48, and the camera control unit 18 changes the setting such that the opening degree of the diaphragm of the diaphragm mechanism unit 11 becomes narrower and the amount of incident light is suppressed.

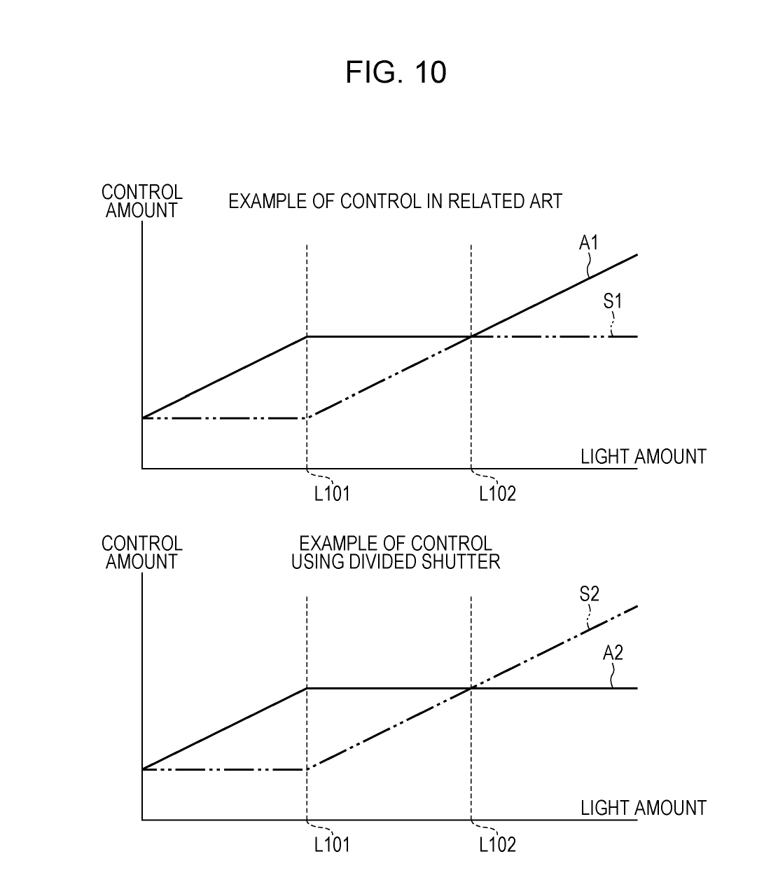

In the related art, in a case where a moving image with extreme brightness of a subject is imaged, as shown in the upper stage of FIG. 10, the brightness of an image is suppressed by setting the opening degree of the diaphragm to be narrow for a purpose of avoiding unnatural movement due to the jerkiness. That is, in this case, the operation mode is considered as the shutter speed-prioritized mode.

Further, in FIG. 10, the horizontal axis represents the amount of incident light and waveforms A1 and A2 of solid lines of the vertical axis represent the control amount of the opening degree of the diaphragm, and when the control amount is larger, the opening degree of the diaphragm becomes narrower. In addition, waveforms S1 and S2 of double-dashed lines of the vertical axis represent the control amount of the shutter speed, and it is considered that the shutter speed is high, that is, the exposure time is shorter when the control amount of the shutter speed is larger. This means that the period set as the divided exposure time is sparse in the synchronization period of the vertical synchronization signal VSYNC when the present technology is applied thereto.

Next, in a case where the light amount is large, when the opening degree of the diaphragm becomes narrower to a light amount L101 at which so-called small diaphragm blur with a degraded resolution because of the light collection in an area wider than the size of respective pixels due to the physical limitation of the condensing area of light is distinguished, controlling the opening degree of the diaphragm is suppressed, the control amount of the shutter speed is increased to an acceptable area of the jerkiness, and the shutter speed is set to be higher, that is, the exposure time becomes shorter.

Moreover, in a case where the light amount is large, the control amount of the shutter speed is increased to the a light amount L102 in which unnatural movement is distinguished due to the jerkiness, and the shutter speed is set to be high, controlling for achieving a balance of the image quality of a frame image imaged as a moving image is made by accepting the small diaphragm blur and narrowing the opening degree again.

Meanwhile, in the present technology, as shown in the lower stage of FIG. 10, since the generation of jerkiness can be suppressed even when the shutter speed is set to be higher, the shutter speed can be shortened in the stage in which the resolution degradation due to the small diaphragm blur is not distinguished and the width of selection of a balance of the image quality of the frame image to be imaged as a moving image can be improved.

Further, as video expression, when imaging is performed with the shutter speed or the opening degree of the diaphragm fixed by the user, since it is possible to set the range of the real time for setting the divided exposure time to be longer even when the shutter speed is set to be higher, it is possible to realize imaging in a freer manner by the setting of the user.

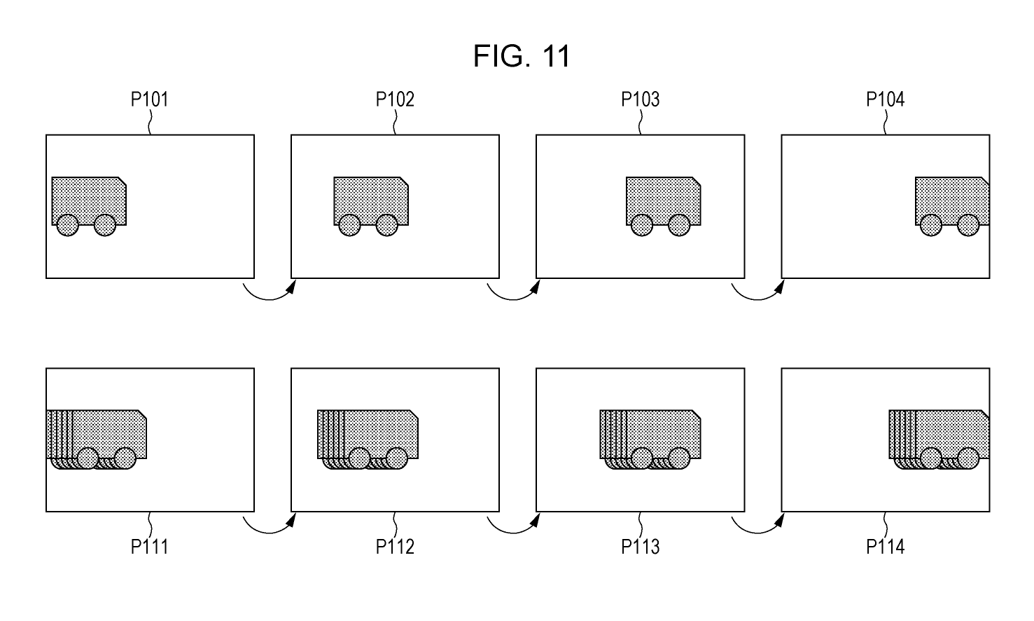

That is, in the related art, when the shutter speed is extremely high, as shown in frame images P101 to P104 of the moving image in the upper stage of FIG. 11, since a vehicle moving to the right direction in the figure is imaged with a high speed at the fixed timing, the vehicle is imaged as a clear image with a less blur. However, since the imaging is performed in the above-described manner, it is difficult to express smooth flow with continuity even when the frame images P101 to P104 are continuously reproduced, consequently, so-called jerkiness may be generated.

Meanwhile, in a case where the present technology is applied, by setting the divided exposure time obtained by dividing the total exposure time to be sparse at predetermined intervals in the synchronization period of the vertical synchronization signal VSYNC, an image with a blur in accordance with the movement is continuously imaged without changing the necessary total exposure time in each of the frame images as shown in the frame images P111 to P114 of the lower stage of FIG. 11. As a result, in a case where the frame images P111 to P114 are continuously reproduced as a moving image, since all images are with a blur in accordance with the movement of the vehicle serving as a subject, the continuity between images are recognized and suppression of the jerkiness is possible.

Further, as described above, in the process of the related art, when the shutter speed is extremely high, as shown in frame images P101 to P104 of the moving image in the upper stage of FIG. 11, since a vehicle moving to the right direction of the figure in each of the frame images P101 to P104 is imaged with a high speed at the fixed timing, the vehicle is imaged as a clear image with a less blur. Further, in the still image mode, it is possible to image a clear still image with a less blur by the process in the related art.

Modification Example of Light Receiving Element

In the description above, in the imaging element 14, the light receiving elements P1 to Pn supply a pixel signal to the A/D conversion circuit 101 when the pixel signal is generated in any of the divided exposure time, and the example of accumulating the pixel signal converted into the digital signal in the memory unit 55 has been described. However, the pixel signal generated at the divided exposure time may not be a digital signal and may be accumulated as an analog signal in each of the light receiving elements P1 to Pn.

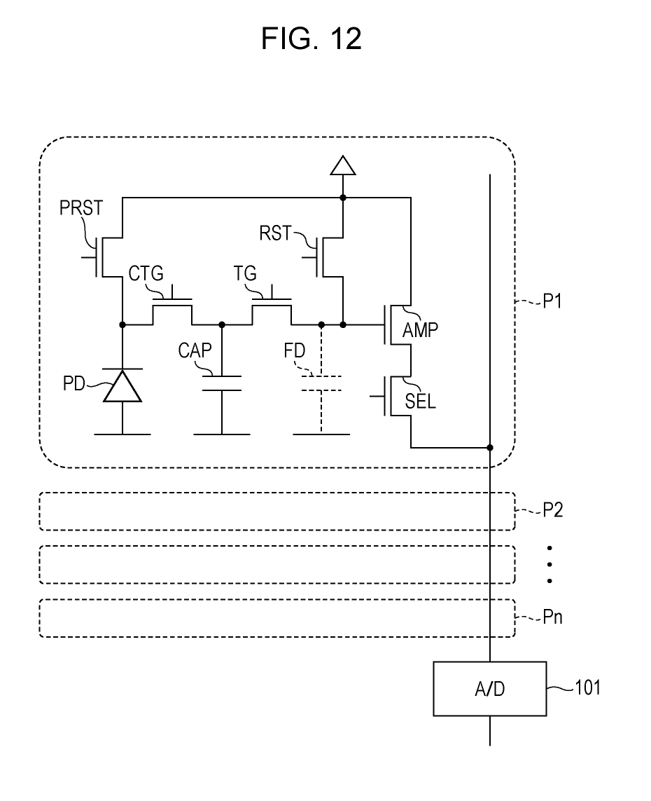

In FIG. 12, the pixel signal generated at the divided exposure time may be a digital signal. For example, FIG. 12 shows a configuration example of the light receiving elements P1 to Pn, in which a pixel signal for the total exposure time is accumulated as an analog signal, output to the A/D conversion circuit 53, and then converted into a digital signal in each of the light receiving elements P1 to Pn. Since the same reference numerals and the same reference signs are denoted to the configuration with a function which is the same of that of the configuration of the light receiving element described with reference to FIG. 4, the description thereof will not be repeated.

That is, in the light receiving element of FIG. 12, a difference from the light receiving element of FIG. 4 is that a photodiode reset transistor PRST, an accumulation and transfer transistor CTG, and an accumulation unit CAP are newly provided. The photodiode reset transistor PRST is a transistor for discharging the charge accumulated in the photodiode PD, and the charge of the photodiode PD is discharged when the transistor is turned ON.

The accumulation and transfer transistor CTG subsequently transfers the charge accumulated in the photodiode PD to the floating diffusion FD at the divided exposure time.

The accumulation unit CAP sequentially accumulates the charge accumulated by the photodiode PD at the divided exposure time and transfers the charge accumulated only by the total exposure time to the floating diffusion FD through the transfer transistor TG.

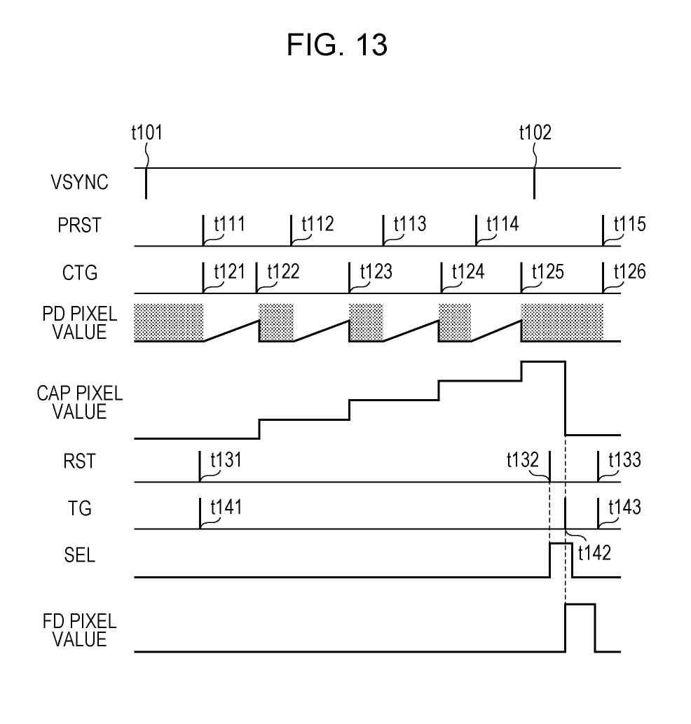

Operation of light receiving element of FIG. 12 Next, the operation of the light receiving element of FIG. 12 will be described with reference to the timing chart of FIG. 13. Further, the timing chart of FIG. 13 shows an example in which the exposure time is divided into four time periods. Further, FIG. 13 shows the vertical synchronization signal VSYNC, the timing of the photodiode reset signal PRST, the timing of the accumulation and transfer signal CTG, the pixel value (PD pixel value) accumulated in the photodiode PD, the pixel value (CAP pixel value) accumulated in the accumulation unit CAP, the timing of the reset signal RST, the timing of the transfer signal TG, and the timing of the selection signal SEL, and the pixel value (FD pixel value) accumulated in the floating diffusion FD from the upper side, and the horizontal axis represents time.

Therefore, in the timing in which the photodiode reset signal PRST, the accumulation and transfer signal CTG, the reset signal RST, the transfer signal TG, and the selection signal SEL are Hi, the photodiode reset transistor PRST, the accumulation transfer transistor CTG, the reset transistor RST, the transfer transistor TG, and the selection transistor SEL in FIG. 12 are turned ON, but turned OFF in another timing.

That is, as shown in the uppermost stage to the third stage, the sixth stage, and the seventh stage of FIG. 13, in a time t111 (=t121=t131=t141) at which a predetermined time is passed from a time t101 which is the synchronization period of the vertical synchronization signal VSYNC, the photodiode reset signal PRST, the accumulation and transfer signal CTG, the reset signal RST, and the transfer signal TG are all Hi. In this manner, the photodiode reset transistor PRST, the accumulation and transfer transistor CTG, the reset transistor RST, and the transfer transistor TG are all turned ON, the photodiode PD, the accumulation unit CAP, and the floating diffusion FD are all reset, and initial exposure is started by the light receiving array 52.

Next, as shown in the third to fifth stages from the upper side of FIG. 13, in a time t122 at which the divided exposure time is passed from the time t111, by the accumulation and transfer signal CTG being Hi, the accumulation and transfer transistor CTG is turned ON for an extremely short period of time, the pixel accumulated in the photodiode PD is transferred to the accumulation unit CAP, and the pixel value in the divided exposure time which is an initial quarter of the total exposure time is accumulated.

Next, as shown in the uppermost stage, the second stage, and the fourth stage in FIG. 13, in a time t112 at which a predetermined time is passed from a time t122 at which the accumulation and transfer transistor CTG is turned off, the photodiode reset signal is Hi, the photodiode reset transistor PRST is turned ON, the charge remaining in the photodiode PD is discharged to be reset, and exposure of the divided exposure time of the second time period is started.

As shown in the third to the fifth stages from the upper side of FIG. 13, a time t123 at which the divided exposure time is passed from the time t112 at which the divided exposure of the second time period is started, the accumulation and transfer transistor CTG is turned ON for an extremely short period of time by the accumulation and transfer signal CTG being Hi for an extremely short period time, the pixel accumulated in the photodiode PD is transferred to the accumulation unit CAP, and the pixel value in the divided exposure time, which is a second quarter of the total exposure time is added and then accumulated.

Hereinafter, in times t113 to t124, and t114 to t125, the same process is repeated such that the pixel values at the third time and the fourth time of the divided exposure time are accumulated in the accumulation unit CAP at the time t125.

When a predetermined time is passed after the time t102 which is an initiation time of the synchronization period of the next vertical synchronization signal VSYNC is passed, the selection signal SEL becomes Hi at the time t132 as shown in the eighth stage of FIG. 13, the selection transistor SEL is turned ON, and the resets signal RST becomes Hi for an extremely short period of time as shown in the sixth stage of FIG. 13 at this timing.

In this manner, the reset transistor RST is turned ON, the floating diffusion FD is reset, and a reset signal including switch noise due to the dark current at the time of resetting is supplied to the A/D conversion circuit 101 to be converted into the digital signal. Further as shown in the seventh and the ninth stages of FIG. 13, the pixel signal formed of the analog signal of the total exposure time which is accumulated in the accumulation unit CAP is transferred to the floating diffusion FD by the transfer signal TG becoming Hi for an extremely short period of time at the time t142. At this time, since the selection transistor SEL is in an ON state, the pixel signal formed of the analog signal generated by exposure during only the total exposure time is transferred to the A/D conversion circuit 101 to be converted into the digital signal, and then accumulated in the frame memory 102.

That is, by performing such a process, the pixel signal formed of the analog signal accumulated at the divided exposure time is added by the total exposure time, and the pixel signal can be converted into the digital signal to be output. As a result, in addition to the above-described effects according to the present technology, it is possible to reduce a load of the arithmetic circuit 54. Further, by the accumulation unit CAP being provided in the light receiving element, generation of the pixel signal can be realized by division exposure even when the frame memory 102 of FIG. 4 is omitted.

Accordingly, in regard to the configuration of the light receiving element, the frame memory 102 accumulating the pixel signal converted into the digital signal described with reference to FIG. 4 may have a configuration having the accumulation unit CAP in a pixel with reference to FIG. 12 in addition to a built-in type.

Further, the example of equally dividing the necessary exposure time has been described in the above, but the exposure time may not be necessarily divided equally and the divided exposure time may be divided unequally when the integration time of the divided exposure time is divided so as to be the necessary exposure time. Further, the interval between the divided exposure times, that is, the time to be unexposed may not be equal. In addition, in the above description, the example in which the number of times of division of the necessary exposure time is two or four has been described, but the number of times of division may be more than four and the period in which the divided exposure time is set may be controlled by rate control using Pulse Width Modulation (PWM) control or the like.

By performing the above-described process, it is possible to set the real-time exposure to be performed longer while shortening the total exposure time by dividing the exposure time into a plurality of time periods to make the shutter speed in each of the divided exposure time variable and it is possible to improve the image quality of a frame image to be imaged by suppressing the jerkiness at the time of a short shutter speed in the moving image mode.

In addition, in this manner, the shutter speed can be used for decreasing the light amount. Accordingly, as the imaging apparatus, since imaging with decreased sensitivity becomes possible without replacing an attachment, such as an ND filter, which decreases the light amount, it is possible to improve the operability of the user.

In addition, an effect of suppressing blur of a moving object may be exhibited by switching the operation to an operation of shortening the exposure time as in the related art when a still image is imaged, and it is possible to perform optimum shutter control in a case where imaging targets or expression methods between the moving image mode and the still image mode are different from each other.

On the other hand, the series of processes described above can be allowed to be executed by software as well as hardware. A program constituting the software is installed from a recording medium to a computer in which dedicated hardware is incorporated or a general-purpose personal computer which can perform various functions by installing various programs therein in a case where a series of processes are executed by the software.

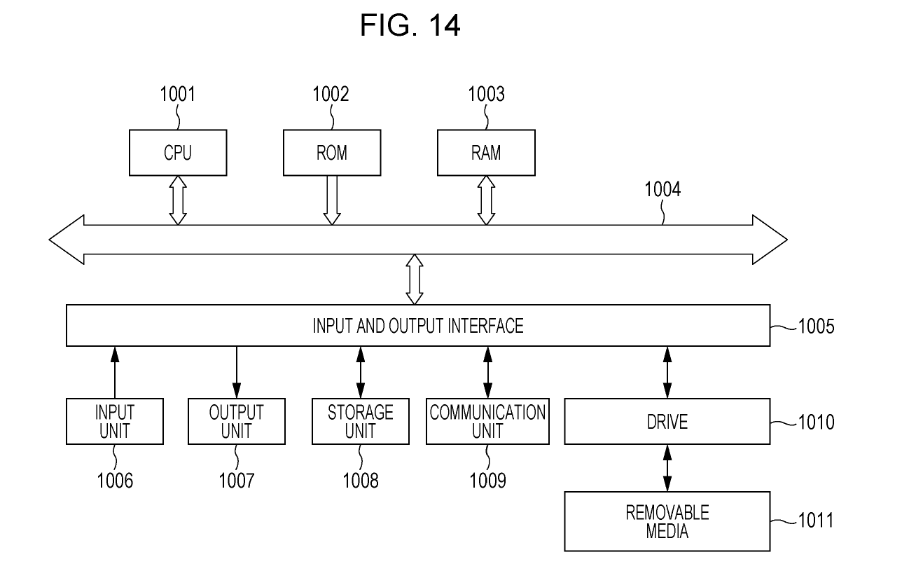

FIG. 14 shows a configuration example of a general-purpose personal computer. The personal computer has a Central Processing Unit (CPU) 1001 incorporated therein. An input and output interface 1005 is connected to the CPU 1001 through a bus 1004. A Read Only Memory (ROM) 1002 and a Random Access Memory (RAM) 1003 are connected to the bus 1004.

A keyboard to which an operation command is input by a user, an input unit 1006 formed of an input device such as a mouse, an output unit 1007 which outputs an image of a processing operation screen or a processing result to a display device, a storage unit 1008 formed of a hard disk drive or the like that stores programs or various pieces of data, and a communication unit 1009 that is formed of a Local Area Network (LAN) adaptor and performs communication processing through a network represented by the Internet are connected to the input and output interface 1005. Further, a drive 1010 that reads and writes data with respect to removable medium 1011 such as a magnetic disc (including a flexible disc), an optical disc (including a Compact Disc-Read Only Memory (CD-ROM) and a Digital Versatile Disc (DVD)), a magneto-optical disc (including Mini Disc (MD)), and a semiconductor memory is connected thereto.

The CPU 1001 executes various programs according to a program stored in the ROM 1002 or programs read by the removable medium 1011 such as a magnetic disc, an optical disc, a magneto-optical disc, and a semiconductor memory, installed in the storage unit 1008, and then downloaded to the RAM 1003 from the storage unit 1008. Further, data necessary for executing various processes by the CPU 1001 is appropriately stored in the RAM 1003.

In the computer configured in the above-described manner, the series of processes described above are carried out by the CPU 1001 executing programs stored in the storage unit 1008 to be downloaded to the RAM 1003 through the input and output interface 1005 and the bus 1004.

Programs executed by the computer (CPU 1001) can be provided by being recorded in the removable medium 1011 as package media or the like. Further, the programs can be provided through a wired or wireless transmission medium such as a local area network, the Internet, and a digital satellite broadcasting.

In the computer, programs can be installed in the storage unit 1008 through the input and output interface 1005 by mounding the removable medium 1011 on the drive 1010. In addition, the programs can be installed in the storage unit 1008 by being received in the communication unit 1009 through a wired or wireless transmission medium. In addition, programs can be installed in the ROM 1002 or the storage unit 1008 in advance.

In addition, the programs executed by the computer may be programs in which processes are performed in time series according to the procedures described in the present specification and/or programs in which processes are performed in the necessary timing when a call is made or the like.

In addition, in the present specification, the system means aggregation of a plurality of constituent components (devices, modules (components), and the like) and all constituent components are not necessarily included in the same housing. Therefore, both of a plurality of devices accommodated in separate housings and connected through a network or one device in which a plurality of modules are accommodated in one housing are systems.

In addition, the embodiments of the present technology are not limited to the above-described embodiments and various modifications are possible within the range not departing from the scope of the present technology. For example, the present technology may employ cloud computing in which one function is processed by being shared and cooperated by a plurality of devices through a network.

Further, each step described in the flowcharts above can be performed by one device or a plurality of devices in a cooperative manner.

Furthermore, in a case where a plurality of processes are included in one step, the plurality of processes included in one step can be performed by one device or a plurality of devices in a cooperative manner.

In addition, the present technology may employ the following configurations:

(1) An image sensor including: an imaging element that generates a pixel signal through photoelectric conversion with a variable exposure time; and an accumulation unit that accumulates the pixel signal generated by the imaging element, in which the imaging element repeatedly generates the pixel signal through the photoelectric conversion for each of the divided exposure time periods obtained by dividing a necessary exposure time which is necessary for imaging an image into multiple time periods at intervals of a predetermined time within an imaging time of one frame image, and the accumulation unit accumulates the pixel signal generated by the imaging element and outputs the pixel signal accumulated in the necessary exposure time.

(2) The image sensor according to (1), further including a conversion unit that converts the pixel signal formed of an analog signal output by the imaging element into a digital signal, in which the accumulation unit accumulates the pixel signal converted into the digital signal by the conversion unit.

(3) The image sensor according to (2), further including an arithmetic unit that reads the pixel signal accumulated in the accumulation unit, adds the pixel signal converted into the digital signal by the conversion unit to the read pixel signal, and writes the pixel signal back to the accumulation unit when the pixel signal is generated by the imaging element for each of the divided exposure times.

(4) The image sensor according to any one of (1) to (3), further including a divided exposure time determining unit that determines the divided exposure time based on a signal level of the pixel signal output by the accumulation unit.

(5) The image sensor according to (4), in which the divided exposure time determining unit shortens the divided exposure time by a predetermined time when the signal level of the pixel signal output by the accumulation unit is saturated in a case where a moving image is imaged at a predetermined opening degree of a diaphragm.

(6) The image sensor according to (1), in which the accumulation unit is provided in the imaging element.

(7) The image sensor according to (6), in which the accumulation unit accumulates the pixel signal as the analog signal.

(8) The image sensor according to (1), in which each of the divided exposure times are separated from each other.

(9) A method of operating an image sensor which includes an imaging element that generates a pixel signal through photoelectric conversion with a variable exposure time, and an accumulation unit that accumulates the pixel signal generated by the imaging element, the method including: causing the imaging element to repeatedly generate the pixel signal through the photoelectric conversion for each of the divided exposure time periods obtained by dividing a necessary exposure time which is necessary for imaging an image into multiple time periods at intervals of a predetermined time within an imaging time of one frame image; and causing the accumulation unit to accumulate the pixel signal generated by the imaging element and output the pixel signal accumulated in the necessary exposure time.

(10) An imaging apparatus including: an imaging element that generates a pixel signal through photoelectric conversion with a variable exposure time; and an accumulation unit that accumulates the pixel signal generated by the imaging element, in which the imaging element repeatedly generates the pixel signal through the photoelectric conversion for each of the divided exposure time periods obtained by dividing a necessary exposure time which is necessary for imaging an image into multiple time periods at intervals of a predetermined time within an imaging time of one frame image, and the accumulation unit accumulates the pixel signal generated by the imaging element and outputs the pixel signal accumulated in the necessary exposure time.

It should be understood by those skilled in the art that various modifications, combinations, sub-combinations and alterations may occur depending on design requirements and other factors insofar as they are within the scope of the appended claims or the equivalents thereof.

What is claimed is:

1. An image sensor comprising:
an imaging element that generates a pixel signal through photoelectric conversion with a variable exposure time; and
an accumulation unit that accumulates the pixel signal generated by the imaging element,
wherein the imaging element repeatedly generates the pixel signal through the photoelectric conversion for each of the divided exposure time periods obtained by dividing a necessary exposure time which is necessary for imaging an image into multiple time periods at intervals of a predetermined time within an imaging time of one frame image, and
the accumulation unit accumulates the pixel signal generated by the imaging element and outputs the pixel signal accumulated in the necessary exposure time.

2. The image sensor according to claim 1, further comprising a conversion unit that converts the pixel signal formed of an analog signal output by the imaging element into a digital signal,
wherein the accumulation unit accumulates the pixel signal converted into the digital signal by the conversion unit.

3. The image sensor according to claim 2, further comprising an arithmetic unit that reads the pixel signal accumulated in the accumulation unit, adds the pixel signal converted into the digital signal by the conversion unit to the read pixel signal, and writes the pixel signal back to the accumulation unit when the pixel signal is generated by the imaging element for each of the divided exposure times.

4. The image sensor according to claim 1, further comprising a divided exposure time determining unit that determines the divided exposure time based on a signal level of the pixel signal output by the accumulation unit.

5. The image sensor according to claim 4, wherein the divided exposure time determining unit shortens the divided exposure time by a predetermined time when the signal level of the pixel signal output by the accumulation unit is saturated in a case where a moving image is imaged at a predetermined opening degree of a diaphragm.

6. The image sensor according to claim 1, wherein the accumulation unit is provided in the imaging element.

7. The image sensor according to claim 6, wherein the accumulation unit accumulates the pixel signal as the analog signal.

8. The image sensor according to claim 1, wherein each of the divided exposure times are separated from each other.

9. A method of operating an image sensor which includes an imaging element that generates a pixel signal through photoelectric conversion with a variable exposure time, and an accumulation unit that accumulates the pixel signal generated by the imaging element, the method comprising:
causing the imaging element to repeatedly generate the pixel signal through the photoelectric conversion for each of the divided exposure time periods obtained by dividing a necessary exposure time which is necessary for imaging an image into multiple time periods at intervals of a predetermined time within an imaging time of one frame image; and
causing the accumulation unit to accumulate the pixel signal generated by the imaging element and output the pixel signal accumulated in the necessary exposure time.

10. An imaging apparatus comprising:
an imaging element that generates a pixel signal through photoelectric conversion with a variable exposure time; and
an accumulation unit that accumulates the pixel signal generated by the imaging element,
wherein the imaging element repeatedly generates the pixel signal through the photoelectric conversion for each of the divided exposure time periods obtained by dividing a necessary exposure time which is necessary for imaging an image into multiple time periods at intervals of a predetermined time within an imaging time of one frame image, and
the accumulation unit accumulates the pixel signal generated by the imaging element and outputs the pixel signal accumulated in the necessary exposure time.
